(19) United States
(12) Patent Application Publication
(10) Pub. No.: US 2009/0202913 A1
(43) Pub. Date: Aug. 13, 2009

(54) NEGATIVE ELECTRODE FOR NONAQUEOUS SECONDARY BATTERY

(75) Inventors: Yoshiki Sakaguchi, Saitama (JP); Hideaki Matsushima, Saitama (JP)

Correspondence Address: YOUNG & THOMPSON, 209 Madison Street, Suite 500, ALEXANDRIA, VA, 22314, US

(73) Assignee: MITSUI MINING & SMELTING CO.,LTD., Tokyo (JP)

(21) Appl. No.: 12/307,019

(22) PCT Filed: Apr. 10, 2007
(86) PCT No.: PCT/JP2007/057888

§ 371 Date: Dec. 30, 2008

(30) Foreign Application Priority Data
Jun. 30, 2006 (JP) 2006-182852

(51) Int. Cl. H01M 4/40

(52) U.S. Cl. 429/231.95

(57) ABSTRACT

A negative electrode 10 for a nonaqueous secondary battery includes an active material layer 12 containing active material particles 12a. The active material particles 12a are coated at least partially with a metallic material 13 having low capability of forming a lithium compound. The active material layer 12 has voids formed between the metallic material-coated active material particles 12a. The metallic material 13 has an average crystallite size of 0.01 to 1 μm and covers 5% to 95% of the surface of the particles 12a. The metallic material covering the surface of the particles preferably has a thickness of 0.05 to 2 μm on average.

### TECHNICAL FIELD

This invention relates to a negative electrode for a nonaqueous secondary battery.

### BACKGROUND ART

Assignee of the present invention previously proposed in Patent Document 1 a negative electrode for a nonaqueous secondary battery including a pair of surface (front and back surfaces) brought into contact with an electrolyte and having electroconductivity, and an active material layer interposed between the surfaces. A metallic material having low capability of forming a lithium compound is present over the whole thickness of the active material layer such that the active material particles exist in the penetrating metallic material. Owing to the structure of the active material layer, even if the active material particles pulverize as a result of repeated expansion and contraction accompanying charge and discharge cycles, there is less likelihood of the particles falling off the negative electrode. Thus, the proposed negative electrode provides the advantage of an extended battery life.

As a result of further investigations, the present inventors have found that the above-described negative electrode is, while able to prevent the active material particles from falling off with charge/discharge cycles, liable to produce electrically isolated particles with repetition of charge/discharge cycles depending on the degree of penetration of the metallic material into the active material layer. In detail, the metallic material in the negative electrode has a crystallite size as large as 5 to 6 μm. Therefore, when the active material particles pulverize to the order of submicrometer with charge/discharge cycles, pulverization of the metallic material proceeds only to the crystallite size, i.e., 5 to 6 μm. As a result, the active material particles can be electrically isolated to lose an electrical interconnection with the neighboring particles, which can induce deterioration of capacity.

Patent Document 1 US 2006-0121345A1

Accordingly, an object of the invention is to provide a negative electrode for a nonaqueous secondary battery with further improved performance over the above-described conventional technique.

### DISCLOSURE OF THE INVENTION

The invention provides a negative electrode for a nonaqueous secondary battery comprising an active material layer containing particles of an active material,

the particles being coated with a metallic material having low capability of forming a lithium compound,

the active material layer having voids formed between the metallic material-coated particles,

the metallic material having an average crystallite size of 0.01 to 1 μm and covering 5% to 95% of the surface of the particle.

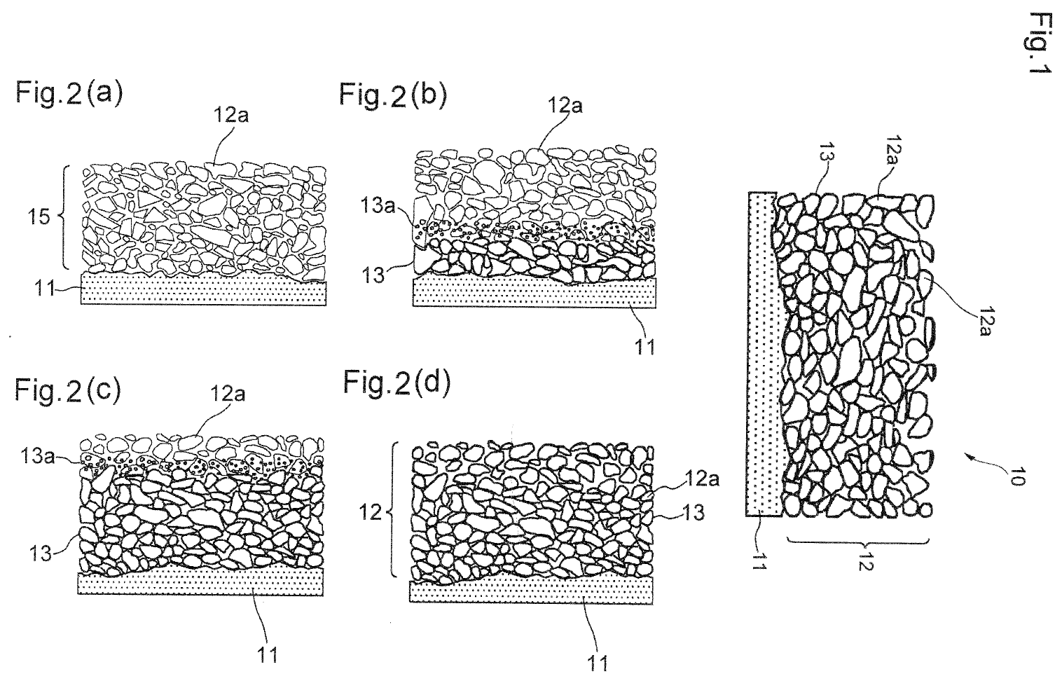

FIG. 1 schematically illustrates a cross-sectional structure of an embodiment of the negative electrode for a nonaqueous secondary battery according to the invention.

FIG. 2 illustrates diagrams of a process of producing the negative electrode of FIG. 1.

### DETAILED DESCRIPTION OF THE INVENTION

The present invention will be illustrated based on its preferred embodiment with reference to the accompanying drawing. FIG. 1 is a schematic cross-sectional view of a preferred embodiment of the negative electrode for a nonaqueous secondary battery according to the invention. The negative electrode 10 of the present embodiment has a current collector 11 and an active material layer 12 on at least one side of the current collector 11. Although FIG. 1 shows only one active material layer 12 for the sake of convenience, the active material layer may be provided on both sides of the current collector 11.

The active material layer 12 contains particles 12a of an active material. The active material is a material capable of absorbing and releasing lithium ions and exemplified by silicon based materials, tin based materials, aluminum based materials, and germanium based materials. An exemplary and preferred tin based material as an active material is an alloy composed of tin, cobalt, carbon, and at least one of nickel and chromium. A silicon based material is particularly preferred to provide an improved capacity density per weight of a negative electrode.

Examples of the silicon based material include materials containing silicon and capable of absorbing lithium ions, such as elemental silicon, alloys of silicon and metal element(s), and silicon oxides. These materials may be used either individually or as a mixture thereof. The metal making the silicon alloy is one or more elements selected from, for example, Cu, Ni, Co, Cr, Fe, Ti, Pt, W, Mo, and Au. Preferred of these elements are Cu, Ni, and Co. Cu and Ni are more preferred in terms of their high electron conductivity and low capability of forming a lithium compound. The silicon based material as an active material may have lithium absorbed either before or after assembling the negative electrode into a battery. A particularly preferred silicon based material is elemental silicon or silicon oxide for its high lithium absorption capacity.

In the active material layer 12, the particles 12a are coated with a metallic material 13 having low capability of forming a lithium compound. In FIG. 1, the metallic material 13 is depicted as a thick solid line defining the perimeter of the individual particles 12a for the sake of clarify of the drawing. The metallic material 13 is different from the material making up the particles 12a. The metallic material 13 is disposed between the particles 12a and is used mainly for the purpose of securing electron conductivity between the particles 12a and containing the particles 12a in the active material layer 12. FIG. 1 is a two-dimensionally schematic illustration of the active material layer 12 so that some of the particles 12a in the active material layer 12 are depicted with no contact with the neighboring particles. In fact, the individual particles are in contact with one another either directly or via the metallic material 13. The metallic material 13 has electroconductivity and is exemplified by copper, nickel, iron, cobalt, and their alloys. A highly ductile metallic material is preferred, which forms a stable electroconductive metallic network throughout the whole active material layer 12 against expansion and contraction of the active material particle 12a. A preferred example of such a material is copper. As used herein, the expression “low capability of forming a lithium compound” means no capability of forming an intermetallic compound or a solid solution with lithium or, if any, the capability is so limited that the resulting lithium compound contains only a trace amount of lithium or is unstable.

There are voids formed between the particles 12a coated with the metallic material 13. That is, the metallic material 13 covers the surface of the particles 12a while leaving interstices through which a nonaqueous electrolyte containing lithium ions may reach the particles 12a.

In the active material layer 12, it is preferred that the metallic material 13 on the surface of the active material particles 13a is present throughout the thickness of the active material layer 12 in a manner that the particles 12a exist in the matrix of the metallic material 13. By such a configuration, as mentioned below, the state that the pulverized particles 12a are covered with the metallic material 13 maintains even when they pulverize due to expansion and contraction accompanying charge/discharge cycles. As a result, electron conductivity across the active material layer 12 is secured by the metallic material 13 so that occurrence of an electrically isolated particle 12a, especially in the depth of the active material layer 12, is prevented effectively. This is particularly advantageous in the case where a semiconductive, poorly electron-conductive active material, such as a silicon based material, is used as an active material. Whether the metallic material 13 is present throughout the thickness of the active material layer 12 can be confirmed by mapping the metallic material 13 using an electron microscope.

The metallic material 13 discontinuously covers the surface of the particles 12a. A nonaqueous electrolyte is supplied to the particles 12a mostly through the part of the surface of the particles 12a that is not coated with the metallic material 13. In the present embodiment, the degree of the coating on the surface of the particles 12a with the metallic material 13 is 5% to 95%, preferably 50% to 95%, even more preferably 80% to 90%, of the surface of the particles 12a. When the degree of the coating with the metallic material exceeds 95%, by the reason that the metallic material 13 covers nearly the entire surface of the particles 12a, the polarization in initial charge will be increased. If the degree of coating with the metallic material 13 is less than 5%, the metallic material is so scarce on the surface of the particles 12a that the electron conductivity of the whole active material layer 12 is insufficient.

The degree of the particles 12a being coated with the metallic material 13 is ought to be evaluated in terms of the ratio of the metallic material-coated area with the metallic material 13 to the total surface area of the particles 12a. Nevertheless, it is technically difficult to measure the degree of coating in terms of the area ratio. Then in the present invention a cross-section of the active material layer 12 is observed under an SEM to measure the cross-section's perimeter of the individual particles 12a and the total length of the coat of the metallic material 13 on the individual particles 12a. The total length of the coat of the metallic material 13 is divided by the cross-section's perimeter of the particle 12a, and the quotient is multiplied by 100. The percentage is referred to as a degree of the particles 12a being coated with the metallic material 13 or, simply, a degree of coating.

In order for the metallic material 13 to well conform to the expansion and contraction of the active material particles 12a, it is advantageous that the coat of the metallic material 13 has a deformable structure. More specifically, it is advantageous that the coat of the metallic material 13 present on the surface of the particle 12a is composed of an aggregate of crystallites of the metallic material 13 because the coat of the metallic material 13 will be easily deformed on a crystallite-by-crystallite basis. Having low capability of forming a lithium compound as stated, the metallic material 13 does not absorb/release lithium ions and therefore undergoes no volumetric change.

The coat of the metallic material 13 being an aggregate of crystallites is advantageous in that the metallic material 13 pulverizes into individual crystallites according as the particles 12a pulverize with the progress of charge and discharge. With the progress of charge and discharge cycles, there is produced a state in which the particles 12a and the crystallites are mixed up, so that the particles 12a are prevented from becoming electrically isolated. Electron conductivity is thus secured.

Even when the coat of the metallic material 13 is composed of an aggregate of the crystallites of the metallic material 13, and even when the degree of coating with the metallic material is within the above specified range, the metallic material coat is apt to come off the particles 12a with the expansion and contraction of the particles 12a if the size of the crystallites of the metallic material 13 is large. This is because the metallic material coat has limited freedom of deformation when the size of the crystallites of the metallic material 13 is large. This tends to result in production of electrically isolated particles 12a, making it difficult to improve the cycle characteristics. From this viewpoint, it is preferred for the crystallites to have an average particle size of 0.01 to 1 μm, more preferably 0.05 to 0.4 μm. The average particle size of the crystallites is measured by observing a cross-section of the active material layer under an SEM or SIM. Since the metallic material 13 does not undergo volumetric change with charge/discharge in nature of its component, the size of the crystallites undergoes substantially no change over the total charge/discharge cycles.

In order for the coat of the metallic material 13 to have increased freedom of deformation so as to conform well to the expansion and contraction of the particles 12, it is preferred for the metallic material 13 to have a small thickness. It is specifically preferred that the thickness of the metallic material 13 covering the active material particles 12a is in the range of from 0.05 to 2 μm, more preferably from 0.1 to 0.25 μm. With the average thickness being within the range, the coat of the metallic material 13 tends to deform easily while ensuring the electrical connection between the particles 12a. The thickness of the coat of the metallic material 13 is measured by observing a cross-section of the active material layer 12 under an SEM. As used herein, the term “average thickness” denotes an average calculated from the thicknesses of the metallic material coat actually covering the surface of the particle 12a. The non-coated part of the surface of the particle 12a with the metallic material 13 is excluded from the basis of calculation.

A coat of the metallic material 13 having the above described structure is formed by, for example, depositing the metallic material 13 on the surface of the particles 12a by electroplating under the conditions described infra.

To further improve the cycle characteristics, it is advantageous to utilize the active material particles 12a over the whole thickness of the active material layer 12 in the electrode reaction. For this, absorption and release of lithium ions should be conducted uniformly throughout the thickness of the active material layer 12. From this viewpoint it is preferred that the active material layer 12 has voids through which nonaqueous electrolyte containing lithium ions is allowed to pass smoothly throughout the thickness. It is advantageous for the nonaqueous electrolyte to have easy access to the active material particles 12a in order to reduce the overpotential in initial charging. Reduction of the overpotential prevents lithium dendrite formation on the negative electrode which causes a short circuit between the electrodes. Reduction of the overpotential is also advantageous in that decomposition of the nonaqueous electrolyte, which causes an increase of irreversible capacity, is prevented. Reduction of the overpotential is also beneficial to protect the positive electrode from damage.

As described below, The active material layer 12 is preferably formed by applying a slurry containing the particles 12a and a binder to a current collector, drying the applied slurry to form a coating layer, and electroplating the coating layer in a plating bath having a prescribed composition to deposit a metallic material 13 between the particles 12a.

To form necessary and sufficient voids in the active material layer for a nonaqueous electrolyte to pass though the layer, it is preferred that a plating bath thoroughly penetrates the coating layer. In addition to this, it is preferred that the conditions for depositing the metallic material 13 by electroplating using the plating bath be properly selected. Such conditions include the composition and pH of the plating bath and the electrolytic current density. The pH of the plating bath is preferably 7.1 to 11. With a plating bath having a pH in that range, the surface of the active material particles 12a is cleaned (while dissolution of the particles 12a is suppressed), which accelerates deposition of the metallic material 13 thereon, while leaving moderate voids between the particles 12a. The pH value as referred to herein is as measured at the plating temperature.

In order to reduce the size of the crystallites of the metallic material 13 as previously described, it is preferred to produce a large quantity of plating nuclei. This can be achieved by selecting an appropriate electroplating condition that produces a large amount of plating nuclei, for example, an increased current density or a lowered temperature, or by using particles 12a with a large particle size.

In plating with copper as a metallic material 13, a copper pyrophosphate plating bath is preferably used. In using nickel as a metallic material, an alkaline nickel bath, for example, is preferably used. To use a copper pyrophosphate plating bath is advantageous in that the aforementioned voids can easily be formed throughout the thickness of the active material layer 12 even when the active material layer 12 has an increased thickness. Using a copper pyrophosphate bath offers an additional advantage that the metallic material 13, while being deposited on the surface of the active material particles 12a, is hardly deposited between the particles 12a so as to successfully leave voids located between the particles 12a. In using a copper pyrophosphate bath, a preferred composition and pH of the bath and preferred electrolysis conditions are as follows.
Copper pyrophosphate trihydrate: 85-120 g/l
Potassium pyrophosphate: 300-600 g/l
Potassium nitrate: 15-65 g/l
Bath temperature: 45-50° C.
Current density: 4-7 A/dm²
pH: adjusted to 7.1 to 9.5, by the addition of aqueous ammonia and polyphosphoric acid.

When in using a copper pyrophosphate bath, the bath preferably has a P ratio, which is defined to be a weight ratio of P₂O₇ to Cu (P₂O₇/Cu), of 5 to 12, more preferably 8 to 11. With a bath having a P ratio in that range, it is easy to control the degree of coating the surface of the particles 12a with the metallic material 13 and the crystallite size of the metallic material 13 within the above recited respective ranges.

When in using an alkaline nickel bath, a preferred composition and pH of the bath and preferred electrolysis conditions are as follows.
Nickel sulfate: 100-250 g/l
Ammonium chloride: 15-30 g/l
Boric acid: 15-45 g/l
Bath temperature: 45-50° C.
Current density: 4-7 A/dm²
pH: adjusted to 8-11 by the addition of 100-300 g/l of 25 wt % aqueous ammonia.

Plating using the copper pyrophosphate bath is preferred to plating using the alkaline nickel plating bath; for the former tends to take the result that the active material particles 12a are successfully coated with the metallic material 13 (i.e. copper in this case), and tends to form adequate voids in the active material layer 12 thereby providing a negative electrode with a prolonged life as compared with the latter plating.

Various additives used in an electrolytic solution for the production of copper foil, such as proteins, active sulfur compounds, and cellulose compounds, may be added to the plating bath to appropriately control the characteristics of the metallic material 13.

The active material layer 12 formed by the above mentioned various methods preferably has a void fraction (=porosity) of about 15% to 45%, more preferably about 20% to 40%, by volume. With the void fraction arranging within that range, there are formed voids necessary and sufficient to allow for passage of a nonaqueous electrolyte in the active material layer 12. The void fraction is measured in accordance with the following procedures (1) through (7).

(1) Measure the weight per unit area of a coating layer formed by application of the above described slurry. Calculate the weights of the particles 12a and of the binder from the composition ratio of the slurry.
(2) After electroplating, calculate the weight of the deposited plating metal species from the weight gain per unit area.
(3) After electroplating, observe a cross-section of the resulting negative electrode under an SEM to measure the thickness of the active material layer 12.
(4) Calculate the volume per unit area of the active material layer 12 from the thickness of the active material layer 12.
(5) Calculate the volume each of the particles 12a, the binder, and the plating metal species from their respective weights and the composition ratio of the slurry.
(6) Subtract the volumes per unit area of the particles 12a, the binder, and the plating metal species from the volume per unit area of the active material layer 12 to give the void volume.
(7) Divide the void volume by the volume per unit area of the active material layer 12, and multiply the quotient by 100 to give a percent void fraction.

The ratio of the metallic material 13 coating the surface of the active material particles 12a may also be controlled easily to the above specified range by proper choice of the particle size of the active material particles 12a. From this viewpoint, the particles 12a preferably have an average particle size of 10.0 to 4.0 μm, more preferably 1.5 to 3.0 μm, in terms of D₅₀. And the particles 12a preferably have a maximum particle size of 30 μm or smaller, more preferably 10 μm or smaller. The particle size measurement is made with a laser diffraction scattering particle size analyzer or an electron microscope (SEM).

In the present embodiment, when the amount of the active material in the negative electrode is too small, it is difficult to sufficiently increase the energy density. When the amount is too large, the active material is likely to come off. A suitable thickness of the active material layer 12 for these considerations is preferably 10 to 40 μm, more preferably 15 to 30 μm, even more preferably 18 to 25 μm.

The negative electrode 10 of the present embodiment may or may not have a thin surface layer (not shown in the drawing) on the active material layer 12. The thickness of the surface layer is as thin as 0.25 μm or less, preferably 0.1 μm or less. There is not lower limit to the thickness of the surface layer.

In the absence of a surface layer or in the presence of a very thin surface layer on the negative electrode 10, the overpotential in initial charging of a secondary battery assembled by using the negative electrode 10 can be minimized. This means that reduction of lithium on the surface of the negative electrode 10 during charging the secondary battery is avoided. Reduction of lithium can lead to the formation of lithium dendrite that can cause a short circuit between the electrodes.

In the cases where the negative electrode 10 has a surface layer, the surface layer covers the surface of the active material layer 12 continuously or discontinuously. Where the surface layer continuously covers the active material layer 12, the surface layer preferably has a number of micropores (not shown in the drawing) open on its surface and connecting to the active material layer 12. The micropores preferably extend in the thickness direction of the surface layer. The micropores enable passage of a nonaqueous electrolyte. The role of the micropores is to supply a nonaqueous electrolyte into the active material layer 12. The amount of the micropores is preferably such that when the negative electrode 10 is observed from above under an electron microscope, the ratio of the area covered with the metallic material 13, namely a coating ratio, is not more than 95%, more preferably 80% or less, even more preferably 60% or less.

The surface layer is formed of a metallic material having low capability of forming a lithium compound. The metallic material forming the surface layer may be the same or different from the metallic material 13 present in the active material layer 12. The surface layer may be composed of two or more sublayers of different metallic materials. Taking into consideration ease of production of the negative electrode 10, the metallic material 13 present in the active material layer 12 and the metallic material forming the surface layer are preferably the same.

Any current collector conventionally used in negative electrodes for nonaqueous secondary batteries can be used as the current collector of the negative electrode in the present embodiment. The current collector 11 is preferably made out of the above-described metallic material having low capability of forming a lithium compound, examples of which are given previously. Preferred of them are copper, nickel, and stainless steel. Copper alloy foil typified by Corson alloy foil is also usable. Metal foil preferably having a dry tensile strength (JIS C2318) of 500 MPa or more, for example, Corson alloy foil having a copper coat on at least one side thereof is also useful. A current collector having dry elongation (JIS C2318) of 4% or more is preferably used. A current collector with low tensile strength is liable to wrinkle due to the stress of the expansion of the active material. A current collector with low elongation tends to crack due to the stress. Using a current collector made of these preferred materials ensures the folding endurance of the negative electrode 10. The thickness of the current collector 11 is not critical in the present embodiment, preferably 9 to 35 μm in view of the balance between retention of strength of the negative electrode 10 and improvement of energy density. In the case of using copper foil as a current collector 11, it is recommended to subject the copper foil to anti-corrosion treatment, like chromate treatment or treatment with an organic compound such as a triazole compound or an imidazole compound.

A preferred process of producing the negative electrode 10 of the present embodiment will then be described with reference to FIG. 2. The process includes the steps of forming a coating layer on a current collector 11 using a slurry containing particles of an active material and a binder and subjecting the coating layer to electroplating.

As illustrated in FIG. 2(a), a current collector 11 is prepared, and a slurry containing active material particles 12a is applied thereon to form a coating layer 15. The slurry contains a binder, a diluting solvent, etc. in addition to the active material particles. The slurry may further contain a small amount of particles of an electroconductive carbon material, such as acetylene black or graphite. Where, in particular, the active material particles 12a are silicon-based material particles, it is preferred to add the electroconductive carbon material in an amount of 1% to 3% by weight based on the active material particles 12a. With less than 1% by weight of an electroconductive carbon material, the slurry has a reduced viscosity so that the active material particles 12a cause sedimentation easily in the slurry, which can result in a failure to form a desired coating layer 15 with uniform voids. If the electroconductive carbon material content exceeds 3% by weight, plating nuclei tend to concentrate on the surface of the electroconductive carbon material, which can also result in a failure to form a desired coating layer. Examples of the binder include styrene-butadiene rubber (SBR), polyvinylidene fluoride (PVDF), polyethylene (PE), and ethylene-propylene-diene monomer (EPDM). Examples of the diluting solvent include N-methylpyrrolidone and cyclohexane. The slurry preferably contains about 30% to 70% by weight of the active material particles 12a and about 0.4% to 4% by weight of the binder. A diluting solvent is added to these materials to prepare the slurry.

The coating layer 15 thus formed has fine vacant spaces between the particles 12a. The current collector 11 with the coating layer 15 is then immersed in a plating bath containing a metallic material 13 having low capability of forming a lithium compound. Whereupon, the plating bath infiltrates into the vacant spaces and reaches the interface between the coating layer 15 and the current collector 11. In this state, electroplating is conducted to deposit the plating metal species on the surface of the particles 12a (we call electroplating of this type “penetration plating”). Penetration plating is performed by immersing the current collector 11 as a cathode and a counter electrode (anode) in the plating bath and connecting the two electrodes to a power source.

It is preferred to have the metallic material 13 deposited in a direction from one side to the opposite side of the coating layer 15. Specifically, electroplating is carried out in a manner such that deposition of the metallic material 13 proceeds from the interface between the coating layer 15 and the current collector 11 toward the surface of the coating layer 15 as illustrated in FIGS. 2(b) through 2(d). In FIGS. 2(b) through 2(d), the metallic material 13 is depicted as a thick solid line defining the perimeter of the individual particles 12a for the sake of clarify of the drawing. By causing the metallic material 13 to be deposited in that way, the active material particles 12a are successfully coated with the metallic material 13; the crystallite size of the metallic material 13 is controlled easily to the above specified range; further, voids are successfully formed between the metallic material-coated particles 12a coated with the metallic material 13; and, in addition, the above-recited preferred range of the void fraction (porosity) is achieved easily.

The conditions of penetration plating for depositing the metallic material 13 as discussed above include the composition and pH of the plating bath and the electrolytic current density, which have already been described. In order to control, in particular, the degree of coating the surface of the active material particles 12a with the metallic material 13 within the aforementioned preferred range, it is preferred to adjust the current density and the plating bath temperature in the penetration plating.

As shown in FIGS. 2(b) to 2(d), when electroplating is carried out in a manner such that deposition of the metallic material 13 proceeds from the interface between the coating layer 15 and the current collector 11 to the surface of the coating layer, there always are microfine particles 13a comprising plating nuclei of the metallic material 13 in a layer form with an almost constant thickness along the front of the deposition reaction. With the progress of the deposition of the metallic material 13, neighboring microfine particles 13a gather into larger particles, which, with further progress of the deposition, gather one another to continuously coat the surface of the active material particles 12a.

The penetration plating is stopped at the time when the metallic material 13 is deposited throughout the thickness of the coating layer 15. If desired, a surface layer (not shown) may be formed on the active material layer 12 by adjusting the end point of the plating. There is thus obtained a desired negative electrode as illustrated in FIG. 2(d).

The thus obtained negative electrode 10 is well suited for use in nonaqueous secondary batteries, e.g., lithium secondary batteries. In such applications, the positive electrode to be used is obtained as follows. A positive electrode active material and, if necessary, an electroconductive material and a binder are mixed in an appropriate solvent to prepare a positive electrode active material mixture. The active material mixture is applied to a current collector, dried, rolled, and pressed, followed by cutting and punching. Conventional positive electrode active materials can be used, including lithium-containing composite metal oxides, such as lithium-nickel composite oxide, lithium-manganese composite oxide, and lithium-cobalt composite oxide. Also preferred as a positive electrode active material is a mixture of a lithium-transition metal composite oxide comprising LiCoO₂ doped with at least Zr and Mg and a lithium-transition metal composite oxide having a layer structure and comprising LiCoO₂ doped with at least Mn and Ni. Using such a positive electrode active material is promising for increasing a cut-off voltage for charging without reducing the charge/discharge cycle characteristics and thermal stability. The positive electrode active material preferably has an average primary particle size of 5 to 10 μm in view of the balance between packing density and reaction area. Polyvinylidene fluoride having a weight average molecular weight of 350,000 to 2,000,000 is a preferred binder for making the positive electrode; for it is expected to bring about improved discharge characteristics in a low temperature environment.

Preferred separators to be used in the battery include nonwoven fabric of synthetic resins and a porous film of polyolefins, such as polyethylene and polypropylene, or polytetrafluoroethylene. As a separator, for example, a polyethylene porous film (N9420G available from Asahi Kasei Chemicals Corp.) is preferably used. In order to suppress heat generation of the electrode due to overcharge of the battery, it is preferred to use, as a separator, a polyolefin microporous film having a ferrocene derivative thin film on one or both sides thereof. It is preferred for the separator to have a puncture strength of 0.2 to 0.49 N/μm-thickness and a tensile strength of 40 to 150 MPa in the rolling axial direction so that it may suppress the damage and thereby prevent occurrence of a short circuit even in using a negative electrode active material that undergoes large expansion and contraction with charge/discharge cycles.

The nonaqueous electrolyte is a solution of a lithium salt, a supporting electrolyte, in an organic solvent. Examples of the lithium salt include LiClO₄, LiAlCl₄, LiPF₆, LiAsF₆, LiSbF₆, LiBF₄, LiSCN, LiCl, LiBr, LiI, LiCF₃SO₃ and LiC₄F₉SO₃. Examples of suitable organic solvents include ethylene carbonate, diethyl carbonate, dimethyl carbonate, propylene carbonate, and butylene carbonate. A nonaqueous electrolyte containing 0.5% to 5% by weight of vinylene carbonate, 0.1% to 1% by weight of divinyl sulfone, and 0.1% to 1.5% by weight of 1,4-butanediol dimethane sulfonate based on the total weight of nonaqueous electrolyte is particularly preferred as bringing about further improvement on charge/discharge cycle characteristics. While not necessarily elucidated, the reason of the improvement the inventors believe is that 1,4-butanediol dimethane sulfonate and divinyl sulfone decompose stepwise to form a coating film on the positive electrode, whereby the coating film containing sulfur becomes denser.

For use in the nonaqueous electrolyte, highly dielectric solvents having a dielectric constant of 30 or higher, like halogen-containing, cyclic carbonic ester derivatives, such as 4-fluoro-1,3-dioxolan-2-one, 4-chloro-1,3-dioxolan-2-one, and 4-trifluoromethyl-1,3-dioxolan-2-one, are also preferred because they are resistant to reduction and therefore less liable to decompose. An electrolyte containing a mixture of the highly dielectric solvent and a low viscosity solvent with a viscosity of 1 mPa·s or less, such as dimethyl carbonate, diethyl carbonate, or methyl ethyl carbonate, is also preferred for obtaining higher ionic conductivity. It is also preferred for the electrolyte to contain 14 to 1290 ppm, by mass, of fluoride ion. It is considered that an adequate amount of fluoride ion present in the electrolyte forms a coating film of, for example, lithium fluoride on the negative electrode, which will suppress decomposition of the electrolyte on the negative electrode. It is also preferred for the electrolyte to contain 0.001% to 10% by mass of at least one additive selected from the group consisting of an acid anhydride and a derivative thereof. Such an additive is expected to form a coating film on the negative electrode, which will suppress decomposition of the electrolyte. Exemplary and preferred of such additives are cyclic compounds having a —C(—O)—O—C(═O)— group in the nucleus thereof, including succinic anhydride, glutaric anhydride, maleic anhydride, phthalic anhydride, 2-sulfobenzoic anhydride, citraconic anhydride, itaconic anhydride, diglycolic anhydride, hexafluoroglutaric anhydride; phthalic anhydride derivatives, such as 3-fluorophthalic anhydride and 4-fluorophthalic anhydride; 3,6-epoxy-1,2,3,6-tetrahydrophthalic anhydride, 1,8-naphthalic anhydride, 2,3-naphthalenecarboxylic anhydride; 1,2-cycloalkanedicarboxylic acids, such as 1,2-cycxlopentaneedicarboxylic anhydride and 1,2-cyclohexanedicarboxylic anhydride; tetrahydrophthalic anhydrides, such as cis-1,2,3,6-tetrahydrophthalic anhydride and 3,4,5,6-tetrahydrophthalic anhydride; hexahydrophthalic anhydrides (cis-form and trans-form), 3,4,5,6-tetrachlorophthalic anhydride, 1,2,4-benzenetricarboxylic anhydride, and pyromellitic dianhydride; and derivatives of these acid anhydrides.

### EXAMPLES

The present invention will now be illustrated in greater detail with reference to Examples, but it should be understood that the invention is not construed as being limited thereto.

### Example 1

A 18 μm thick electrolytic copper foil as a current collector was cleaned with an acid at room temperature for 30 seconds and washed with pure water for 15 seconds. A slurry of Si particles was applied to the current collector to a thickness of 15 μm to form a coating layer. The slurry contained the particles, styrene-butadiene rubber (binder), and acetylene black at a weight ratio of 100:1.7:2. The particles had an average particle size D₅₀ of 2.5 μm. The average particle size D₅₀ was measured using a laser diffraction scattering particle size analyzer Microtrack (Model 9320-X100) from Nikkiso Co., Ltd.

The current collector having the coating layer was immersed in a copper pyrophosphate plating bath having the following composition, and the coating layer was penetration-plated with copper by electrolysis under the following conditions to form an active material layer. A DSE was used as an anode, and a direct current power source was used.
Copper pyrophosphate trihydrate: 105 g/l
Potassium pyrophosphate: 450 g/l
Potassium nitrate: 30 g/l
P ratio: 7
Bath temperature: 50° C.
Current density: 4 A/dm²
pH: adjusted to 8.2 by the addition of aqueous ammonia and polyphosphoric acid.

The penetration plating was stopped at the time when copper was deposited throughout the thickness of the coating layer. A desired negative electrode was thus obtained. A vertical cross-section of the active material layer was observed under an SEM to find the active material particles coated with a copper coat having an average thickness of 1.5 μm. The degree of coating with copper was 93% with respect to the surface of the Si particles. The copper crystallite size was 0.6 to 1.0 μm.

### Example 2

A negative electrode was fabricated in the same manner as in Example 1, except for changing the P ratio, bath temperature, and current density of the penetration plating as follows.

P ratio: 8.2

Bath temperature: 48° C.

Current density: 4 A/dm²

### Example 3

A negative electrode was fabricated in the same manner as in Example 1, except for changing the P ratio, bath temperature, and current density of the penetration plating as follows.

P ratio: 8.9

Bath temperature: 48° C.

Current density: 5.5 A/dm²

### Comparative Example 1

A negative electrode was fabricated in the same manner as in Example 1, except for replacing the copper pyrophosphate bath with a copper sulfate bath having the following composition with reference to Patent Document 1 cited supra. The electrolysis conditions were: a current density of 5 A/dm², a bath temperature of 40° C., a DSE as an anode, and a direct current power source.

CuSO₄.5H₂O: 250 g/l

H₂SO₄: 70 g/l

### Evaluation

Each of the negative electrodes obtained in Examples and Comparative Examples was assembled into a lithium secondary battery together with LiCo_{1/3}Ni_{1/3}/Mn_{1/3}O₂ as a positive electrode, an electrolyte prepared by dissolving LiPF₆ in a 1:1 by volume mixed solvent of ethylene carbonate and diethyl carbonate in a concentration of 1 mol/l and externally adding 2% by volume of vinylene carbonate to the solution, and a polypropylene porous film of 20 μm thickness as a separator. The number of cycles delivered by the resulting secondary battery at the capacity retention fell to 80% was measured. The capacity retention was obtained by dividing the discharge capacity at the 100th cycle by the initial discharge capacity and multiplying the quotient by 100. The charging was conducted by the CC/CV method at 0.5 C and 4.2 V, and the discharging was conducted at 0.5 C and 2.7 V at a constant current, provided that the C rate was 0.05 C in the 1st cycle, 0.1 C in the 2nd to 4th cycles, 0.5 C in the 5th to 7th cycles, and 1 C in the 8th to 10th cycles. The results obtained are shown in Table 1.

TABLE 1

| | Copper Coat | | | |
|---|---|---|---|---|
| | Degree of Coating | | | Number of |
| | on Surface of Si | | | Cycles with |
| | Particles with | Thickness | Crystallite | 80% Capacity |
| | Copper Coat (%) | (μm) | Size (μm) | Retention |
| Example 1 | 93 | 1.5 | 0.6-1.0 | 100 |
| Example 2 | 95 | 1 | 0.3-0.5 | 120 |
| Example 3 | 95 | 0.6 | 0.05-0.3 | 150 |
| Comp. | 98 | 5 | 5-6 | 40 |
| Example 1 | | | | |

As is apparent from the results in Table 1, Examples show better cycle characteristics than Comparative Example. It is particularly noted that the cycle characteristics are improved according as the crystallite size become smaller.

### INDUSTRIAL APPLICABILITY

According to the present invention, the active material particles of the negative electrode are effectively prevented from falling off even after they pulverize as a result of volumetric changes accompanying charge and discharge cycles, and formation of electrically isolated active material particles is effectively prevented. With the progress of charge and discharge cycles, the metallic material pulverizes into individual crystallites together with the pulverization of the active material particles, eventually resulting in a state in which the active material particles and the metallic material are mixed up. Such a mixed state secures the electron conductivity of the active material layer. A nonaqueous secondary battery having the negative electrode of the invention therefore has excellent cycle characteristics.

1. A negative electrode for a nonaqueous secondary battery comprising an active material layer containing particles of an active material,
the particles being coated with a metallic material having low capability of forming a lithium compound,
the active material layer having voids formed between the metallic material-coated particles,
the metallic material having an average crystallite size of 0.01 to 1 μm and covering 5% to 95% of the surface of the particle.

2. The negative electrode for a nonaqueous secondary battery according to claim 1, wherein the average thickness of the metallic material covering the surface of the particle is 0.05 to 2 μm.

3. The negative electrode for a nonaqueous secondary battery according to claim 1, wherein the metallic material on the surface of the particles is present throughout the thickness of the active material layer.

4. The negative electrode for a nonaqueous secondary battery according to claim 1, wherein the coat of the metallic material is formed by electroplating in a plating bath having a pH higher than 7.1 and not higher than 11.

5. The negative electrode for a nonaqueous secondary battery according to claim 1, wherein the particles are of a material containing silicon and capable of absorbing and releasing lithium ions, and
the metallic material covering the surface of the particles is formed by electroplating performed in a copper pyrophosphate bath having a weight ratio of P₂O₇ to Cu (P₂O₇/Cu) of 5 to 12.

6. A nonaqueous secondary battery comprising the negative electrode according to claim 1.

7. The negative electrode for a nonaqueous secondary battery according to claim 2, wherein the metallic material on the surface of the particles is present throughout the thickness of the active material layer.
